(19) United States
(12) Patent Application Publication
(10) Pub. No.: US 2011/0161889 A1
(43) Pub. Date: Jun. 30, 2011

(54) User Interface for Electronic Devices

(75) Inventors: Roger L. Scheer, Beach Park, IL (US); Rachid M. Alameh, Crystal Lake, IL (US); Andrew W. Lenart, Lake Villa, IL (US)

(73) Assignee: MOTOROLA, INC., Schaumburg, IL (US)

(21) Appl. No.: 12/649,810

(22) Filed: Dec. 30, 2009

(51) Int. Cl. G06F 3/033

(52) U.S. Cl. 715/863

(57) ABSTRACT

An electronic device having a user interface and a display unit on which an object is selected from a source screen in response to a first input at the user interface. The selected object is then tunneled to a target screen, via a virtual tunnel, in response to a second input at the user interface. The source screen and the target screen may be a part of the display unit in the electronic device. The tunneled object is then edited or modified to create an object desired by the user.

### FIELD OF THE DISCLOSURE

The present disclosure relates generally to electronic devices and, more particularly, to porting selected content to a workspace, for example, a content composition application or a desktop in wireless communications device, and corresponding methods.

### BACKGROUND

It is known for an electronic device to provide a user interface and a display screen from which a user may activate, initiate or launch various functions, modes of operation, applications, etc. The user typically uses the user interface and the display screen for messaging text from one device to another device. In general, the text is entered into the device using an input device such as a keypad or a touch screen. However, entering the text by using such an input device is difficult, time consuming, and tedious. Also, entering the text manually using a mobile keypad and limited display size will cause more errors in the text messages. In many devices, entering the text or other data is made difficult by the size and/ or organization of the user interface and in some devices editing is complicated by the user input mechanism. Thus, the use of multiple, complementary input techniques for editing, with touch and non-touch displays are needed to improve the usability of devices and make text creating and editing simpler and faster.

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is a schematic diagram of an electronic device.

FIG. 2 is a flowchart depicting insertion of selected content onto a destination workspace.

FIG. 3 depicts a display arrangement of screen-to-screen tunneling of selected content.

FIG. 4 depicts a display arrangement of application-to-application tunneling of selected content.

FIG. 5 depicts a display arrangement of multiple virtual tunnels.

FIG. 6 depicts a display arrangement showing the virtual tunnel as an icon or a miniature of a destination workspace.

FIG. 7 depicts a display arrangement showing filtering attributes of a virtual tunnel.

FIG. 8 depicts a display arrangement showing security features of the electronic device.

FIG. 9 is a flowchart depicting tunneling of selected portion of an object from a source screen to a target screen.

### DETAILED DESCRIPTION

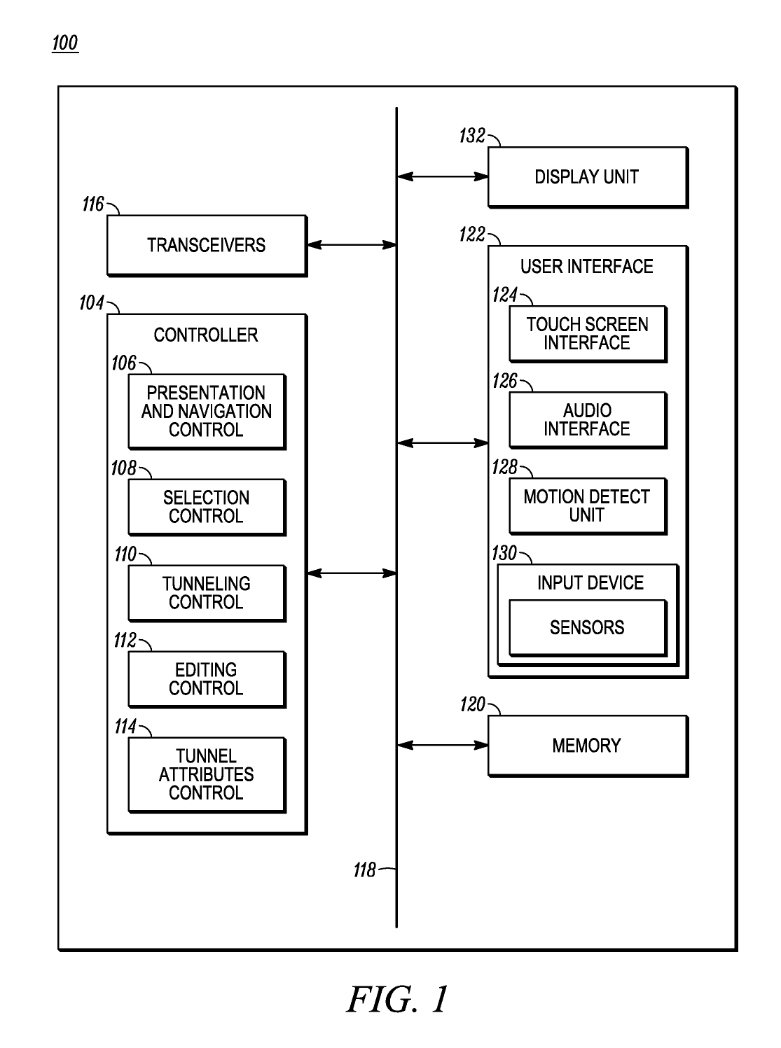

In FIG. 1, an electronic device 100 comprises generally a controller 104 communicably coupled to a display unit 132 and a user interface 122 on or from which a user may select and transfer content from one workspace to another workspace. The content may include characters, words, sentences, paragraphs, text, pictures, graphics, still images, or animation. The user interface 122 may be implemented as either a touch-screen interface, audio interface, motion detector, or any input device, or as a combination thereof as described further below. The electronic device may be embodied as a wireless communication device (such as a cellular telephone), personal digital assistant (PDA), handheld computing device, portable multimedia player, head worn device, headset type device, computer screen, gaming device, kiosk, television, and the like. In other implementations, the electronic device is integrated with a larger system, for example, an appliance or a point-of-sale station or some other consumer, commercial or industrial system. One skilled in the art will recognize that the techniques described herein are generally applicable to any environment where transferring of displayed content is desired or implemented. More particular implementations are described below.

In one embodiment, the controller is embodied as a programmable processor or as a digital signal processor (DSP) or as a combination thereof. In FIG. 1, the controller 104 is coupled to memory 120 via a bidirectional system bus 118 that enables reading from and writing to memory. The memory 120 may be embodied as Flash memory, a hard disk, a multimedia card, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disk, and the like.

In the exemplary embodiment of FIG. 1, the controller 104 executes firmware or software or other instructions stored in memory 120 wherein the instructions enable the operation of some functionality of the electronic device 100 depending on the particular implementation thereof. The memory 120 may also store data (e.g., a phonebook, icons, messages, music files, still images, video, dictionary, etc.) inputted or transferred to or generated on the electronic device 100. In programmable processor implementations, the memory 120 also stores user interface control and operating instructions that enable selecting content on a source workspace, and inserting the selected content onto a destination workspace as described more fully below.

In some embodiments including a programmable processor, the electronic device includes an operating system that hosts software applications and other functional code. In wireless communication implementations, for example, the operating system could be embodied as ANDROID™, SYMBIAN®, WINDOWS MOBILE®, or some other proprietary or non-proprietary operating system. In other electronic devices, some other operating system may be used. More generally, however, the electronic device 100 need not include an operating system. In some embodiments the functionality or operation of the electronic device 100 is controlled by embedded software or firmware. In other embodiments the functionality is implemented by hardware equivalent circuits or a combination thereof. The particular architecture of the operating system and the process of executing programs that control the functionality or operation of the device are not intended to limit the disclosure. The enablement of the general functionality of electronic devices is known generally by those of ordinary skill in the art and is not discussed further herein.

In FIG. 1, the electronic device 100 includes the display unit 132 that is communicably coupled to the controller 104 and the user interface 122. The display unit 132 may include touch screens, non-touch displays, or a combination of touch and non-touch displays. The display 132 unit may have multiple displays of the same or different sizes and resolutions. The display unit may display screens that are physically different, or multiple virtual screens on a single physical screen, or any combination thereof. Further, each screen may display one or more applications for the user.

In accordance with an embodiment, the display unit 132 may display at least the source workspace, the destination workspace, and a virtual tunnel. The source workspace may be any donor workspace having content that is being selected and transferred to a different workspace. The source workspace includes word lists, phrase banks, message archives, libraries, text, pictures, graphics, and animation, documents, or other text messages. The source workspace may be pre-built or constructed by the user on the current device. In another embodiment, the user may build the content of the source workspace on a different device, e.g. computer, and the user may then upload it onto the current device.

Similarly, the destination workspace is a target workspace over which the user transfers or tunnels the content selected in the source workspace. The user may then use the content in the destination workspace for different applications such as texting, email, storing, or document editing/creation etc. It should be noted that in the description below, the source workspace and the destination workspace may also be referred as a source screen and a target screen, respectively. Further, the display unit 132 may have a graphical user interface for selecting and tunneling the content from one workspace to another workspace, and also for modifying or editing the tunneled content.

In accordance with one embodiment, the virtual tunnel is a portal or “tunnel” for transferring/tunneling the content selected in the source workspace to the destination workspace. The virtual tunnel may be positioned between multiple workspaces, multiple screens, or between two or more applications on the same or different screens. The virtual tunnels can be unidirectional or multi-directional between workspaces, screens and/or applications.

The virtual tunnel may be represented as an image or icon on the display. The virtual tunnel may have an entry gate that is displayed separately from the destination workspace and associated with the source workspace, and an exit gate associated with the destination workspace. The entry gate is defined as an inlet for collecting the content selected by the user in the source workspace, and the exit gate is defined as an outlet for placing the selected content, collected at the entry gate, onto the destination workspace. The virtual tunnel may be a “holding tank” or a tunnel clipboard that stores, examines, and/or edits the content. In one embodiment, selected content from the source workspace may be dropped into the “holding tank” that overlaps the source and destination workspaces. Once the required content, such as a desired word or phrase, is built in the holding tank, the user can move it from the holding tank to its final destination workspace. The holding tank may also be referred as an active content composition application that is configured to enable composition of content on the destination workspace. The content composition application is different from the source workspace or the source application.

The virtual tunnel can be configured as an icon, an animated character, or a graphic. The icon may be configured as a miniature version of the destination workspace, allowing objects or content to be dropped onto the icon in the approximate position that the user would like for the objects to appear on the destination workspace. Further, the icon may be opened and shrunk by grabbing a corner and pulling them open or pushing them shut. In one embodiment, the virtual tunnel may be configured as dual cursors, a source cursor in the source workspace for selecting the content, and a destination cursor for placing the selected content onto the destination workspace. For example, the destination cursor is located with a stylus or finger and will stay in place until the highlighted text on the source screen or workspace, with the source cursor, is tapped by the stylus. Tapping or double tapping will activate the insertion into the destination location pointed by the destination cursor. In another embodiment, an entry gate of the icon may be associated with an executable file for a content composition. In this case, the user may select the icon for launching the content composition application before embedding the selecting content, and then the user may open the destination workspace upon launching the content composition application.

In another embodiment, the virtual tunnel may be configured as a physical link to create or pass selected content to a streaming application such as separate screens on the same device employing Blue Tooth, Infrared, or internet links. In one embodiment, the virtual tunnel is embedded within the physical link that maintains tunnel attributes between the source screen and the target screen.

In the exemplary embodiment of FIG. 1, the user interface 122 includes a touch-screen interface 124, audio interface 126, motion detection unit 128, and other input device 130 having necessary sensors. The touch-screen interface 124 is communicably coupled to the display unit 132 for accessing the content on the display unit 132. For example, the user may select a portion of the content on the display unit 132 with a stylus or finger, and the user may place the selected portion of the content onto the entry gate of the virtual tunnel which is later transferred to the destination workspace. In a similar way, the audio interface 126 comprises an audio transducer that produces sound perceptible by the user. In general, the audio interface is used for providing audio or voice commands to select and/or transfer the content from the source workspace.

Further, the motion detection unit 128 is used for selecting and tunneling the content based on the gesture motion or by orienting the electronic device. For example, the electronic device 100 is oriented in a clock-wise direction to place the selected content at the entry gate of the virtual tunnel. The motion detection unit 128 detects motion commands provided by the user. The motion commands include the ability to slide a marker onto a section of text or another object and making a predefined motion with the device to designate the source object or content. The motion commands also include the capability to move marked text or other objects/contents within the destination workspace, e.g. a target document.

Further, in the exemplary embodiment of FIG. 1, the user interface 122 also includes other input devices 130 having one or more controls. Such input devices 130 may be embodied as a hard or soft key or button, thumbwheel, trackball, keypad, dome switch, touch pad or screen, jog-wheel or switch, Voice Recognition (VR) device, Optical Character Recognition (OCR) device, microphone and the like, including combinations thereof. The input device 130 receives user inputs and translates the received inputs into control signals using suitable sensors appropriate for the particular input implementation. The input signals are communicated to the controller 104 over the system bus 118 for interpretation and execution based on the operating instructions.

In one implementation, the electronic device 100 of FIG. 1 is embodied as a portable wireless communication device comprising one or more wireless transceivers 116. In other embodiments, the electronic device includes only a receiver or only a transmitter. The transceiver may be a cellular transceiver, a WAN or LAN transceiver, a personal space transceiver e.g., Bluetooth transceiver, a satellite transceiver, or some other wireless transceiver, or a combination of two or more transceivers. In other implementations, the wireless communication device is capable of only receiving or only transmitting, but not both transmitting and receiving. For example, the device may be embodied in whole or in part as a control device that only receives control signals, for selecting and tunneling the content, from a terrestrial source or from space vehicles or a combination thereof. Generally, the electronic device may include multiple transceivers or combinations of transmitters and receivers. For example, the device may include a communication transceiver and a satellite navigation receiver. In other implementations, neither a receiver nor a transmitter constitutes a part of the device. The operation of the one or more transmitters or receivers is generally controlled by a controller, for example, the controller 104 in FIG. 1.

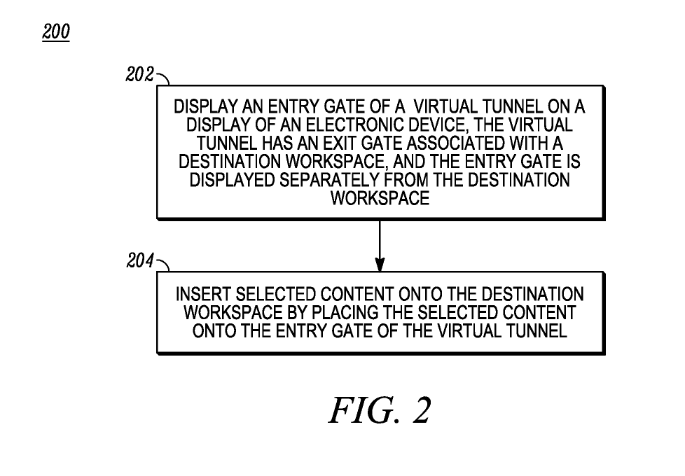

Operationally, one or more work spaces are presented on the display unit in response to a command or input from the user of the electronic device 100. Generally, the controller 104 is configured to present the source workspace from which the content is selected, and the destination workspace over which the content is created or edited. The controller further utilizes presentation and navigation control unit 106 to display the virtual tunnel having the entry gate associated with a source workspace, and the exit gate associated with the destination workspace. In FIG. 2, at 202, the entry gate of the virtual tunnel is displayed on the display of the electronic device. In FIG. 1, the controller then uses a selection control unit 108 to select content from the source workspace. The content may be selected by using touch-screen interface, audio interface, motion detection unit, or any input device, or a combination thereof. The selected content is then placed onto the entry gate of the virtual tunnel.

The controller further utilizes a tunneling control unit 110 for transferring the selected content from the source workspace to the destination workspace. In FIG. 2, at 204, the selected content is inserted onto the destination workspace by placing the selected content onto the entry gate of the virtual tunnel. Moving back to FIG. 1, the controller then utilizes an editing control unit 112 for editing or modifying the tunneled content in the destination workspace. The content may be either edited individually or in combination with other content in the destination workspace.

In another embodiment, the controller may utilize tunnel attributes control unit 114 for filtering the selected content before inserting it onto the destination workspace. Filtering includes security, file conversion, language translation, or format alteration of the selected content.

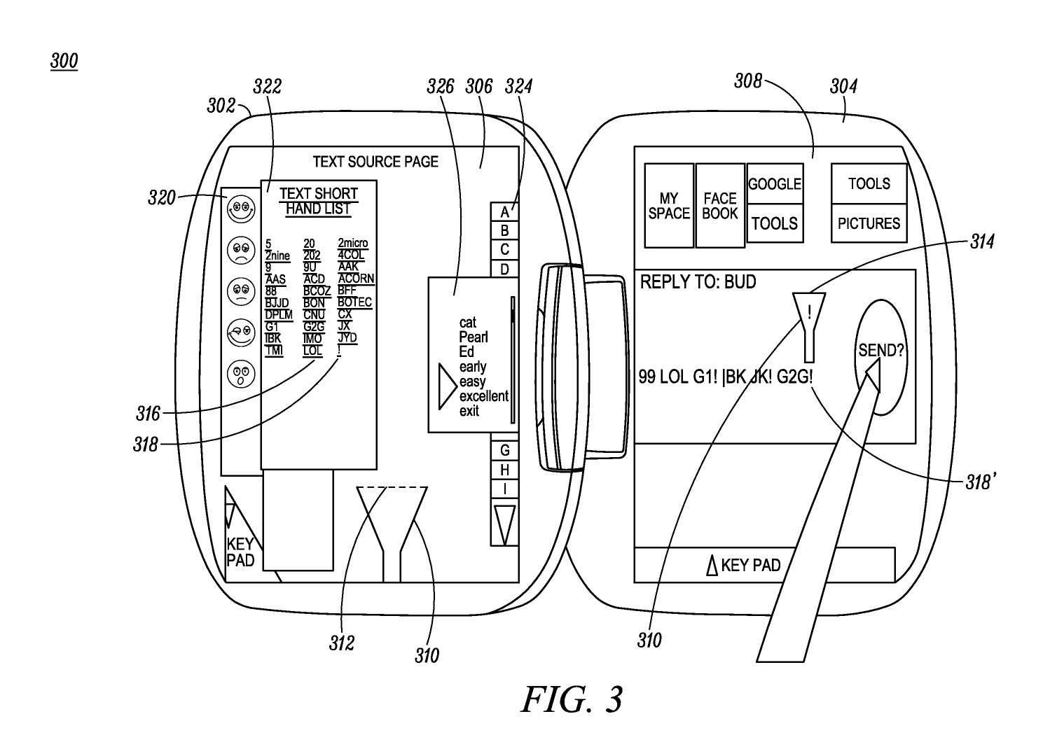

FIG. 3 depicts a display arrangement of an electronic device 302 showing screen-to-screen tunneling of selected content. The electronic device 300 includes a first display 302 that displays a source workspace 306, and a second display 304 that displays a destination workspace 308. It should be noted that the source workspace may be known as a source screen, and the destination workspace may be known as a target screen in the below description. The source work space, in FIG. 3, includes “expression icons” 320 at the left side of the workspace, a text shorthand list 322 next to “expression icons”, and a list of alphabets 324 along with a scroll-down window 326 showing words starting with an alphabet selected by the user on the list of alphabets 324. For example in FIG. 3, the scroll window shows a list of words starting with an alphabet ‘E’ at the right side of the source workspace. Similarly, the destination workspace, in FIG. 3, shows a reply message window with content such as “My Space,” “Face Book,” “Google” “i-Tunes” icons, and system icons such as “tools” for accessing system tools, and “pictures” for accessing pre-stored pictures or images.

Further, the first display 302 also includes a first portion of a virtual tunnel 310 having an entry gate 312 for receiving the selected content from the source workspace 302. The entry gate 312 is associated with the source workspace. In FIG. 3, the entry gate 312 of the virtual tunnel is shown at the bottom of the workspace. Similarly, the second display 304 includes a second portion of the virtual tunnel 310 having an exit gate 314 associated with the destination workspace 308, for placing the selected content onto the destination workspace 308. In FIG. 3, the exit gate 314 is positioned in the reply message window which is shown in the middle of second display 304.

Operationally, the user selects content from the source workspace. For example, in reference to FIG. 3, the user selects an exclamatory mark “!” 318 from the source workspace 306. Upon selecting the content, the user may place the selected content onto the entry gate 312 of the virtual tunnel 310. The user may place the selected content by using any of the user-interface 122 shown in FIG. 1. For example, the user may select by highlighting, circling, underlining, marking the ends of the area containing text, or by drawing a box around the desired text characters. The user may select the content or object by using keyboard input, by touching the object, marking the object with a curser, by Optical Character Recognition, by motion and/or gesturing with the device, by motion and/or gesturing with a separate device linked to the current device 300, by utilizing audio commands or word recognition from audio, or from any combination of these stated input methods. Further, in one embodiment, any combination of keyboard input, touch, Optical Character Recognition (OCR), motion, and/or audio can be used in conjunction with existing TAP or iTAP predictive text methodology. iTAP can be configured to trigger source lists to be browsed and selected from using the any combination of input methods.

Further, the content placed onto the entry gate is then automatically tunneled or transferred to the destination workspace 308 via the exit gate 314 of the virtual tunnel 310. In FIG. 3, the selected content is dropped from the exit gate 314 of the virtual tunnel 310. In one embodiment, the user may position a cursor on the destination workspace before embedding the selected content, and may embed the selected content onto the destination workspace based on the position of the cursor. For example, the user may place the cursor next to a term “G2G” in the destination workspace 308, and the content, e.g. exclamatory mark “!” 318′, is inserted next to the term “G2G” onto the destination workspace.

In another embodiment, the selected content is placed onto the entry gate and a subsequent input is provided to the electronic device 300. For example, the user may place the selected content onto the entry gate, and may press an “OK” or “GO” button to insert the selected content onto the destination workspace. In one more embodiment, the selected content is placed onto the entry gate where it waits for an elapsed time period, after which the selected content is tunneled to the destination workspace 308.

Upon inserting the selected content onto the destination workspace 308, the user may then create, edit, or modify the content to create an object desired by the user. The object may include at least one of text, picture, graphics, link, music file executable, or animation. Objects or the content may be reconfigured within the destination workspace, target screen, application, or document by utilizing keyboard input, by touching and pulling the object, by Optical Character Recognition, by motion and/or gesturing with the electronic device, by motion and/or gesturing with a separate device linked to the electronic device, by utilizing audio commands or by any combination of these methods. The content in the destination workspace may be used for texting, email, and document editing/creation which are primarily used for many wireless products today.

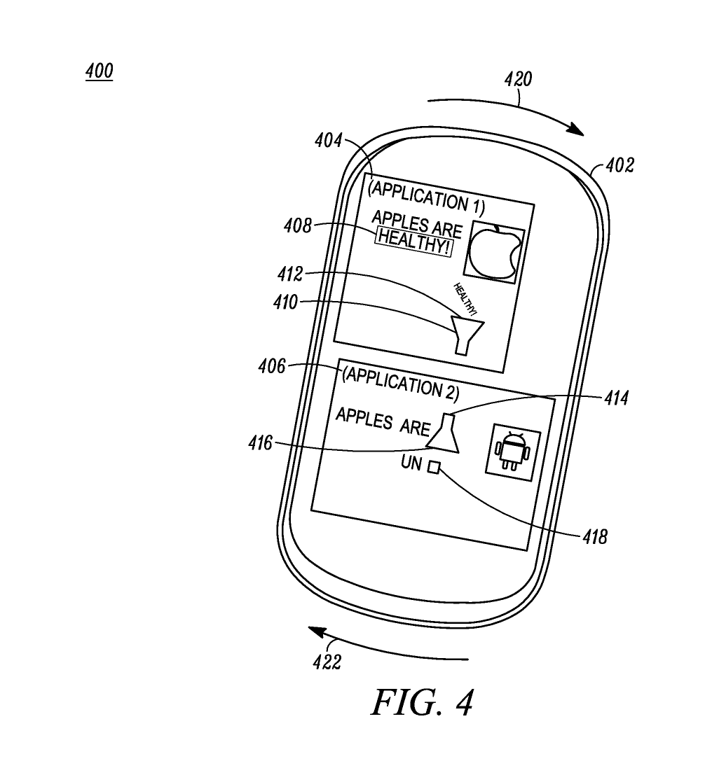

FIG. 4 depicts a display arrangement of an electronic device showing an application-to-application tunneling of selected content. The electronic device 400 may be a candy bar phone which includes a display 402 displaying two applications: application 1 404 having a source workspace; and application 2 406 having a destination workspace. The application 1 is also known as a source application or a source screen, and the application 2 is known as a destination application or a target screen. The electronic device also includes a virtual tunnel whose first portion 410 having an entry gate 412 is positioned in the source workspace, and second portion 414 having an exit gate is positioned in the destination workspace 406. Further, in FIG. 4, the directions 420, 422 indicate the orienting direction of the electronic device 400.

Operationally, the user may select content from the source workspace by using the user interface of the electronic device. The user my select and place the content by gesture motion or by orienting the electronic device in a specified direction or orientation 420, 422. Further, the user may tilt the electronic device in a specified direction relative to the entry gate for dropping the selected content onto the entry gate of the virtual tunnel.

With reference to FIG. 4, the motion detection function of the user interface is described more fully below. The motion detection unit has sensing capability that detects motion commands provided by the user, and accordingly performs a corresponding function in the electronic device. For example, when the electronic device is equipped with a motion detection unit having motion sensing capability, text can be selected by positioning a moving marker over the targeted text by tilting the device and then moving the device in a predetermined manner to lock the marker onto the targeted text. The selected text may be “slid” or “poured” into the tunneling zone by tipping the electronic device in the direction of the tunnel.

Tilting or gesturing the device to select the text requires that the user informs the device via tilting of the start and end of the text of interest. One way to accomplish this is via three successive motions within a timed interval. To highlight text of interest via gesture, within a timed interval, e.g., 3 seconds, the user does three motions: up or down to go to line of interest, followed by left to define start of text followed by right to define end of text, this needs to happen in a preset interval, and then the text is automatically selected, e.g. the term “healthy!”, as shown highlighted in FIG. 4. Then the text is ready to move via further tilt, either to the drop box via tunnel or directly from one screen to the next. When at the right location on the next screen, the user stops further tilt and the text is inserted a second later. The highlighting could also be done via a stylus or finger on a touch screen (touch-slide-let go) or via a navigation key.

The user may also tilt the device and get the cursor on the beginning of the desired text, push a side button marking the text start, tilt to take the cursor to end of the text, push a side button again to mark the end of the selected text, and then tilt the device to move the selected text to the location of interest. Customization features such as switching the device left or right manually to simulate an old typewriter carriage return may also be enabled on an accelerometer equipped device.

In another embodiment, the content is selected and moved to the destination workspace by using motion detection along with touch, side key, key stroke or voice commands. For example, motion enabled text editing command execution in combination with side buttons, touch or keypad entry is described with below steps:

First step (Higlight): the cursor motion is enabled by pressing a side key, and moving the cursor to highlight the required content, e.g., “healthly!” in FIG. 4, keeping the side key pressed. It should be noted that the side key may be substituted with other inputs such as touch, voice, or keypad entry for side key commands.

Second step (Cut & Paste): A preset motion or side key to cut the highlighted content, and a different motion or side key to copy the content. Further, move the cut or copied content to desired location and press side key to drop.

Third step (Delete): The selected or highlighted content may also be deleted by “tossing” motion of the device.

In one embodiment, the motion detection or motion commands are used to select or enable the Tap or iTap or other predictive text algorithm. For example, tilting the phone twice in the direction of the extended word enacts the iTap word.

In another embodiment, the motion commands are used to unlock the source workspace or the whole device or some functionality on the device. Motion commands in combination with touch, voice, keypad, or side key commands are used to unlock or lock the device or some functionality on the device.

Further moving back to the exemplary embodiment of FIG. 4, the user may also select the content, e.g. the text “healthy!” from the source workspace 404 in the source application by a touch-screen interface, and may drag and drop the selected content onto the entry gate. It should be noted that the user may use any of the user interface 122 shown in FIG. 1 for selecting and placing the content onto the entry gate of the virtual tunnel.

Upon selecting the content, the user may place the content onto the entry gate 412 of the virtual tunnel by tilting the electronic device in a specified direction 420, 422 relative to the entry gate 412. In one embodiment, the user may place the content by dragging and dropping the selected content onto the entry gate. The user may drag and drop by using a stylus of a touch-screen interface. It should be noted that dragging and dropping the selected content is not limited to only touch-screen interfaces; it can be performed by using any user interface.

Further, the content placed onto the entry gate is then automatically dropped onto the destination workspace after an elapsed time. For example, the selected content “healthy!” is inserted onto the destination workspace. The user may position a cursor on the destination workspace before embedding the selected content, and embedding the selected content onto the destination workspace based on the position of the cursor. In another embodiment, the user may place the selected content onto the entry gate, and the user may provide a subsequent input for inserting the selected content onto the destination workspace. The subsequent input may be any input provided using the user-interface or the transceiver of the electronic device. Finally, the inserted content is then utilized by the user with or without other content in the destination workspace to create an object such as text, message, image, icon, animated, music file, etc, desired by the user.

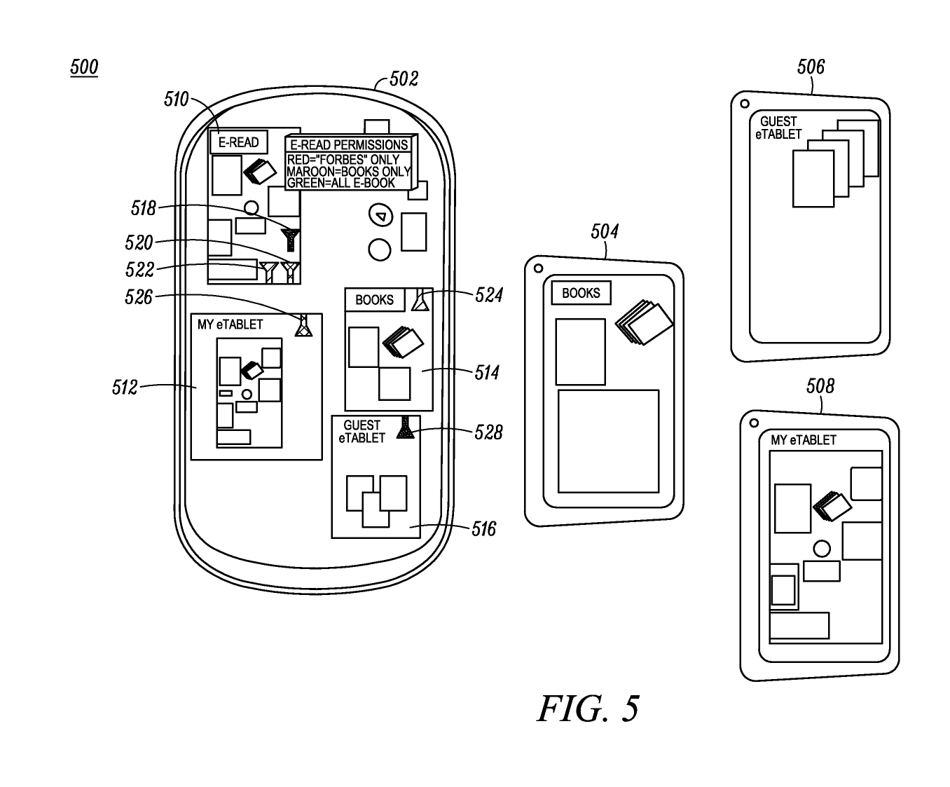

FIG. 5 depicts a display arrangement of an electronic device showing a plurality of virtual tunnels. The electronic device includes a display 502 showing a plurality of workspaces 510, 512, 514, and 516. The workspace 510 is a source workspace which has content required by other workspaces such as 512, 514, and 516. The other workspaces 512, 514, and 516 are known as destination workspaces that obtain data or content from the source workspace 510. Further, each destination workspace is used for collecting a particular type of content from the source workspace. For example, the destination workspace 514 obtains content related to books. In another example, the destination workspace 512 may obtain the favorites of the user from the source workspace. The destination workspaces 512, 514, 516 are also shown as magnified images 508, 504, 506, respectively, in FIG. 5. In another embodiment, the destination workspaces 512, 514, 516 may also correspond to windows/gates of other physical devices connected to the source workspace through virtual tunnels on physical links. For example, the links to E-reader devices are shown where the contents from the source workspace are shared to each e-reader through each respective virtual tunnel.

Further, the source workspace includes a plurality of virtual tunnels, each providing a virtual link to transfer the content to a corresponding destination workspace. For example, the source workspace has a virtual tunnel 522 for tunneling the content to a destination workspace 514 via an exit gate 524. Similarly, a virtual tunnel 520 tunnels the content to a destination workspace 512 via an exit gate 526, and a virtual tunnel 518 tunnels the content to a destination workspace 516 via an exit gate 528. Also each virtual tunnel has a tunnel attribute that filters the content before sending it to the corresponding destination workspace. In one embodiment, the tunnel attributes on each individual tunnel may be set to allow only limited content to be shared with the respective destination workspace and possible remote device. The virtual tunnel may be configured as a two-way tunnel, and the two-way tunnel is controlled to provide access to limited portions of the content or objects on the source workspace, and also to eliminate the need for the user to move content to each individual entry gate. The tunnel attributes on each tunnel may be changed to allow or disallow access of each destination workspace or remote device to objects, content or groups of objects or content.

Operationally, the user selects the content from the source workspace and places the selected content onto an entry gate of the corresponding virtual tunnel. The placed content is then inserted via the exit gate of the corresponding virtual tunnel. For example, the user places the content related to books onto an entry gate of virtual tunnel 522, which is later inserted via the exit gate 524 onto the destination workspace 514. Similarly, the user places the content related to guests onto an entry of virtual tunnel 518, which is later inserted via the exit gate 528 onto the destination workspace 516.

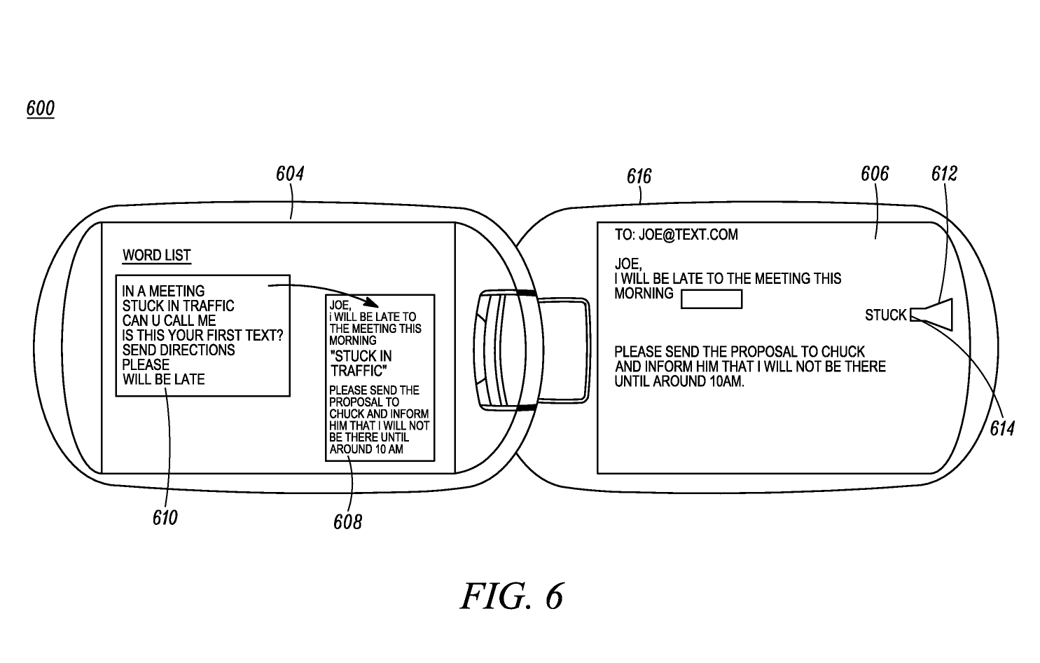

FIG. 6 depicts a display arrangement of an electronic device 600 showing the virtual tunnel 608 as miniature version of a destination workspace 606. This miniature version or showing the virtual tunnel as an icon is to save space on a small display, and for easy transfer of content. For example, the donor/source document can be opened while the destination/receiving document is represented by an icon on the same screen. Text can be dropped into the icon representing the receiving text message. Once the receiving screen is opened, the dropped text can be arranged or edited within the receiving message.

In the exemplary embodiment of FIG. 6, the electronic device 600 includes a first display 604 and a second display 616. The first display 604 includes a source workspace 610, and a first portion 608 of a virtual tunnel representing as miniature version of a destination workspace 606. The second display includes 616 a destination workspace 606 and a second portion 612 of a virtual tunnel having an exit gate 614. The user selects the content and places the selected content onto the first portion 608 of the virtual tunnel which is represented as miniature version of the destination workspace. The content placed in the first portion is later tunneled or inserted onto the actual destination workspace 606, via the second portion 612 of the virtual tunnel. In one embodiment, the content placed onto the miniature version of the destination workspace 606 may be edited or modified before inserting it onto the actual destination workspace 606.

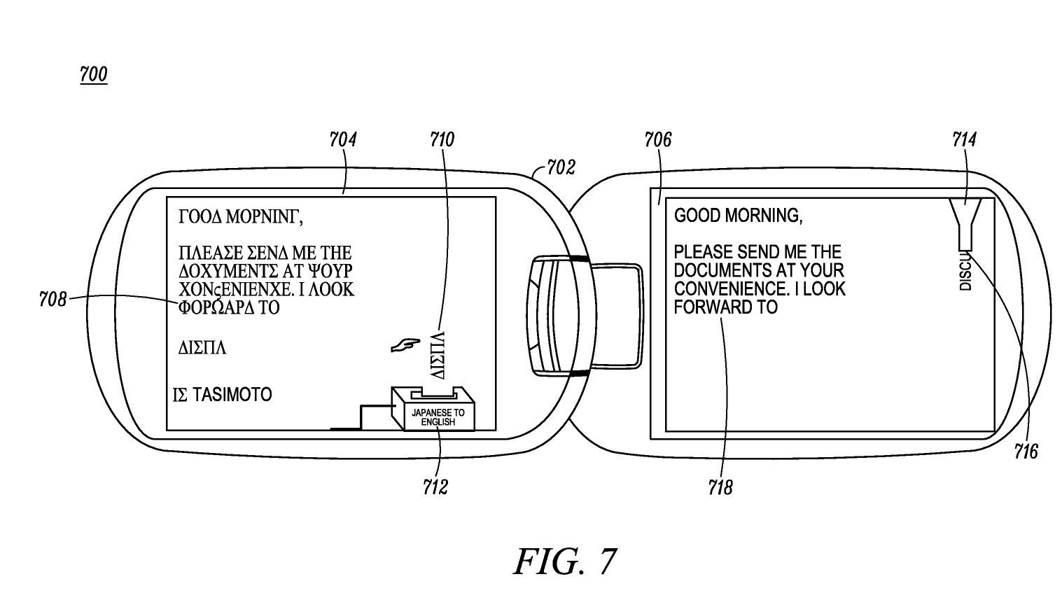

FIG. 7 depicts a display arrangement of an electronic device 700 showing filtering attributes of the virtual tunnel 712, 714. The filtering attributes includes security, file conversion, language translation, or format alteration of the selected content.

In the exemplary embodiment of FIG. 7, the virtual tunnel 712, 714 includes language translator as a filtering attribute. The user selects the content which is in Japanese language from the source workspace 708, and places the selected content onto the virtual tunnel 712. Further, the virtual tunnel 712 applies language translator to the placed content, and translates the content to English language. It should be noted that the language translator may translate from any language to any user desired language.

Upon translating the content to the English language, the content 716 is inserted onto the destination workspace 718, via another portion of the virtual tunnel 714, at a user desired location. It should be noted that the filtering attribute is not limited to a language translator, and it may provide any kind of filtering of the selected content prior to placing it onto the destination workspace 718.

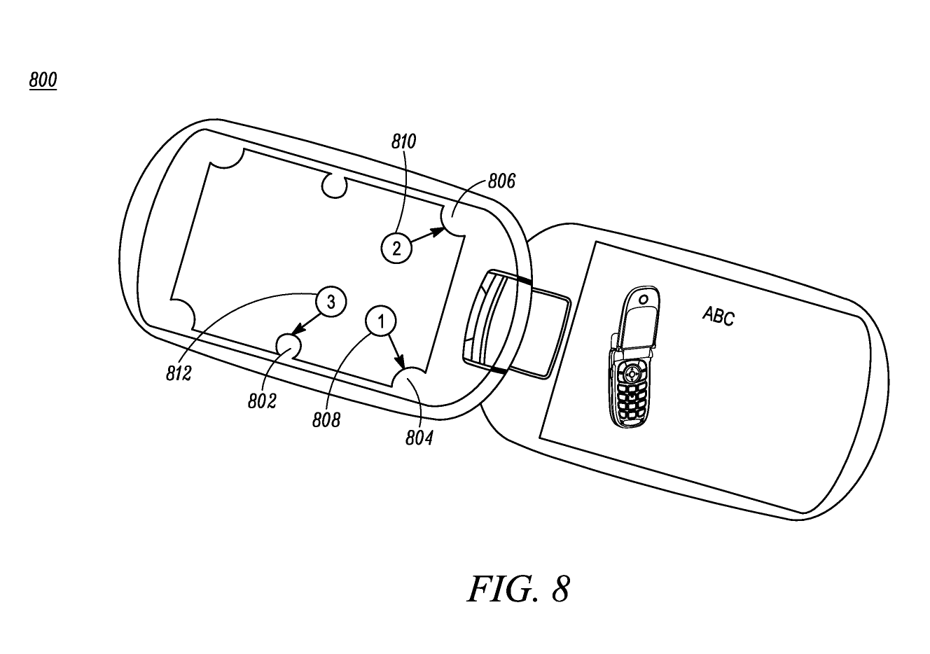

FIG. 8 depicts a display arrangement showing security features of the electronic device 800. The security features includes locking the virtual tunnel so that only the selected portion of the object or content is tunneled from the source screen to the target screen. The virtual tunnel is locked or unlocked by selecting a predefined content and placing it in the virtual tunnel. In another embodiment, the virtual tunnel is configured to be manually closed by a user so as to prevent access to the source screen, and to provide access to only the target screen.

In the exemplary embodiment of FIG. 8, the electronic device 800 shows an interactive screen saver or unlock screen that utilizes the concept of tunnels to enable a security sequence. For understanding of the disclosure, the device is assumed to be locked and the user can only see a locked screen image. The screen image may be designed with any characters such as numbered balls, numbers, letters, animal pictures, etc and a cursor etc. In FIG. 8, the screen image is designed with number balls.

To unlock the device, the user tilts the device and causes a motion cursor to move on top of the visible character/number balls 808 and after a short preset time, say 1 second, that character 808 is highlighted. The user then sends that character to the other screen either via tunneling/tilting or device shaking. The user then repeats the same process for the other characters 810, 812 in the code to get access. For example, if the access code is 1-2-3, the user tilts the device 800 and causes cursor to move on top of 1, then waits a second for selection to take place, then shakes the device or tilts the device 800 to send selection in tunnel 804 to other screen, and repeats for the numbers 2 and 3, causing the device 800 to unlock without touching the keypad and without caring about gesture detection accuracy.

Another interesting application would be to shake the device 800 to cause the numbers/characters to start to cycle, e.g., once a second, like a stop watch, for example, 1 then 2 then 3, then 4, etc. When the number/character of interest is present, the user shakes the device to select which further appears on the next screen. Cycling continues until the user gets access to/unlocks the device, at this point cycling stops. In fact, the user may not need to first shake the device to start the cycling, instead, as soon as the device is locked, it automatically starts to cycle on the locked screen image. To unlock, the user selects the code by shaking the device when on top of the right characters. Once the characters are tunneled, the marked text cannot slide back to the source page. The motion sensing concept can also be utilized in file transfers and gaming applications. It should be noted that the user interface such as motion, touch, voice (audio), or some combination of motion, touch, and voice may be used to move objects into the virtual tunnel in a predetermined sequence to enable a secured event such as unlocking the device or allowing a debit transaction. Similarly, in another embodiment, the user interface such as motion, touch, voice (audio), or some combination of motion, touch, and voice may be used to move objects onto a target screen or application through virtual tunnel, and the moved objects are then arranged on the target screen into a predetermined sequence utilizing motion and/or touch to enable a secured event.

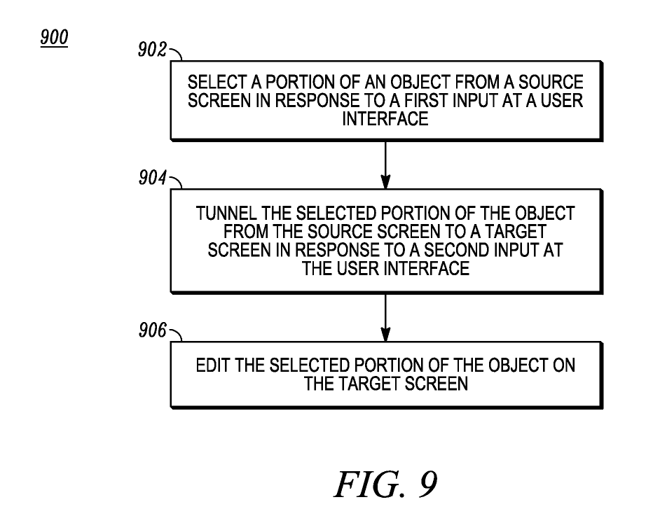

FIG. 9 is a flowchart depicting tunneling of selected portion of an object from a source screen to a target screen. At 902, the user selects a portion of an object from a source screen in response to a first input at a user interface. The source screen is also known as a source workspace. The portion of the object includes at least one of text, picture, graphics, link, executable, or animation. The first input includes at least one of keypad input, touch-screen input, curser input, optical character recognition (OCR) input, audio-command input, or motion-command input.

At 904, the selected portion of the object is tunneled from the source screen to a target screen, via a virtual tunnel, in response to a second input at the user interface. The target screen is also known as a destination workspace. The second input includes at least one of keypad input, touch-screen input, curser input, OCR input, audio-command input, or motion-command input. In one embodiment, the virtual tunnel may be configured to be locked so that only the selected portion of the object is tunneled from the source screen to the target screen. In another embodiment, the virtual tunnel may be configured to be manually closed by a user so as to prevent access to the source screen, and to provide access to only the target screen. The virtual tunnel may also be configured as at least one of an icon, an animated character, or a graphic image, which indicates closing and opening of the virtual tunnel. Further, the source screen may be physically isolated from the target screen, and the virtual tunnel is embedded within a physical link that maintains tunnel attributes between the source screen and the target screen.

In FIG. 9, at 906, the selected portion of the object is edited or modified to create any user desired object such as text messages, emails, images etc. The tunneled content in the destination workspace may be used for texting, email, and document editing/creating that are primarily used for many wireless products and other electronic devices.

Thus, the method of moving the content from one workspace to another workspace as disclosed above, increases the speed and efficiency of the electronic device, especially while text messaging or emailing. Also, the method makes email more feasible on clam-shell phones. The method also includes advantages such as creating or editing the content without a key pad or keyboard, combination of touch and motion enhances text editing and adds capabilities that can be used for security and gaming applications.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in an electronic device having a display interface on which images are presented, the method comprising:
displaying an entry gate of a virtual tunnel on the display of the electronic device,
the virtual tunnel having an exit gate associated with a destination workspace,
the entry gate is displayed separately from the destination workspace;
inserting selected content onto the destination workspace by placing the selected content onto the entry gate of the virtual tunnel.

2. The method of claim 1, placing the selected content onto the entry gate of the virtual tunnel using gesture motion.

3. The method of claim 1, placing the selected content onto the entry gate of the virtual tunnel by orienting the electronic device.

4. The method of claim 3, the electronic device includes a first display and a second display,
the display corresponds to the first display and the destination workspace corresponds to the second display,
inserting selected content onto the destination workspace includes transferring the selected content onto the second display,
placing the selected content onto the entry gate of the virtual tunnel by tilting the electronic device in a specified direction relative to the entry gate.

5. The method of claim 1, placing the selected content onto the entry gate of the virtual tunnel by dragging and dropping the selected content onto the entry gate.

6. The method of claim 1, inserting selected content onto the destination workspace by placing the selected content onto the entry gate and by performing a subsequent input.

7. The method of claim 1, the virtual tunnel has a filtering attribute, applying the attribute to the selected content placed on the entry gate before inserting the content onto the destination workspace.

8. The method of claim 1,
the entry gate is associated with an active content composition application of the electronic device,
the content composition application configured to enable composition of content on the destination workspace.

9. The method of claim 1,
the entry gate is associated with an executable file for the content composition application,
further comprising launching the content composition application by selecting an icon before embedding the content, and opening the destination workspace upon launching the content composition application.

10. The method of claim 9 further comprising positioning a cursor on the destination workspace before embedding the selected content, and embedding the selected content onto the destination workspace based on the position of the cursor.

11. The method of claim 9 further comprising selecting the selected content from a source workspace of a source application and positioning the selected content onto the entry gate by moving the selected content from the source workspace to the entry gate, the source application is different than the content composition application.

12. The method of claim 1,
displaying a plurality of entry gates on the visual interface, each of the plurality of target areas,
each of the plurality of entry gates attributes a different function to content dropped onto the corresponding entry gate,
embedding selected content onto the destination workspace by dropping the selected content onto one of the plurality of entry gates,
wherein the embedded content has an attribute specified by the entry gate onto which the content was dropped.

13. A method in a portable electronic device including a user interface, the method comprising:
selecting a portion of an object from a source screen in response to a first input at the user interface;
tunneling the selected portion of the object from the source screen to a target screen, via a virtual tunnel, in response to a second input at the user interface,
the source screen and the target screen being a part of at least one display in the portable electronic device; and
editing the selected portion of the object on the target screen.

14. The method of claim 13, wherein the portion of the object includes at least one of text, picture, graphics, link, music file executable, or animation.

15. The method of claim 13, wherein the virtual tunnel is configured to be locked so that only the selected portion of the object is tunneled from the source screen to the target screen.

16. The method of claim 13, wherein the virtual tunnel is configured to be manually closed by a user so as to prevent access to the source screen, and to provide access to only the target screen.

17. The method of claim 13, wherein the virtual tunnel is configured as at least one of an icon, an animated character, or a graphic image, which indicates closing and opening of the virtual tunnel.

18. The method of claim 13, wherein the source screen is physically isolated from the target screen, and the virtual tunnel is embedded within a physical link that maintains tunnel attributes between the source screen and the target screen.

19. A portable electronic device comprising:
at least one display having a source screen and a target screen, the source screen having at least a portion of an object to be moved onto the target screen,
the at least one display presenting a visual virtual tunnel between the source screen and the target screen for tunneling the portion of the object;
a controller coupled to the display; and
a user accessible input device coupled to the controller,
the controller configured to select the portion of the object from the source screen in response to a first input at the input device,
the controller configured to tunnel the selected portion of the object from the source screen to the target screen via the visual virtual tunnel in response to a second input at the input device,
the controller configured to edit the selected portion of the object on the target screen to create the message.

20. The device of claim 19, the controller configured to send the selected portion of the object into a first end of a virtual tunnel, and to obtain the selected portion of the object from a second end of the virtual tunnel on the target screen.
